(19) United States
(12) Patent Application Publication
(10) Pub. No.: US 2012/0023029 A1
(43) Pub. Date: Jan. 26, 2012

(54) Method to Capture Direct Patent Infringement By Indirect Infringement Acts

(76) Inventor: Dean E. Geibel, New Cumberland, PA (US)

(21) Appl. No.: 13/187,491

(22) Filed: Jul. 20, 2011

Related U.S. Application Data
(60) Provisional application No. 61/365,853, filed on Jul. 20, 2010.

(51) Int. Cl. G06Q 50/00

(52) U.S. Cl. 705/310

(57) ABSTRACT

The present invention generally relates to claims and methods of drafting patent claims that can be directly infringed by affirmative contributory or inducement acts.

This patent application claims the benefit of U.S. Provisional Patent Application Ser. No. 61/365,853, filed Jul. 20, 2010, entitled “Method to Capture Direct Patent Infringement By Indirect Infringement Acts”.

### BACKGROUND

Infringement of a United States Patent can be established by proof of direct infringement (including literal infringement or infringement under the doctrine of equivalents), or by proof of the aiding or abetting of a direct infringement by another party (i.e. inducing infringement or contributory infringement—collectively termed “indirect” infringement herein).

Direct infringement is the most straightforward type of infringement to establish as, except for considerations attendant to monetary recovery calculation, the intent of the infringer is not an issue.

Infringement claims based on inducement or on contributory infringement require a proof of direct infringement. However, unlike direct infringement, indirect infringement also requires proof of a mens rea element. The patentee has to prove that the party being charged with indirect infringement has the intent to cause the direct infringement. Effectively, this means the patent owner has to show that party had knowledge of the patent being enforced and that his acts would result in direct infringement of it. Intent is difficult to prove and in most situations must be inferred from conduct of the infringer. For an inducement type of claim, such proof, for example, may be in the form of suggestions, showings, teachings, instructions, demonstrations, or explanations made by the charged party, the carrying out of which result in direct infringement. For contributory infringement, proof that the party being charged had the necessary intent can be inferred from the transfer of a component that is a material part of an invention or knowing that it is especially made or especially adapted for use in an infringement of a patent. Proof of transfer of a staple article or commodity of commerce suitable for substantial non-infringing use cannot support an inference of intent. Further, opinions of counsel are frequently used to negate an inference of intent.

In most patent enforcement situations, there is a party against whom direct infringement can be proven. However that may not be an attractive or practical remedy for the patentee, especially if the direct infringer is a customer of the patentee.

Some commentators have hinted that the difficulties in proving indirect infringement should lead patent prosecutors to write claims that will be directly infringed by a competitor. In most cases, drafting claims that are directly infringed is straight forward. However, as mentioned above, enforcing such claims is often more problematic, especially when the direct infringer is a customer.

Another issue is patent damages. If a patentee manufactures electrical connectors, and not printed circuit boards, enforcement of a printed circuit board patent will likely yield the electrical connector manufacturer a reasonable royalty. It is much better, from a commercial standpoint, to recover lost electrical connector profits from a direct competitor that is also supplying electrical connectors.

A need exists for a mechanism that allows a patentee to protect its intellectual property without facing the prospect of suing a direct or indirect customer. This is especially the case when the patentee sells one element of a claimed combination and use of the combined combination enhances the functionality of that element.

### SUMMARY

This invention gives patentees a way of establishing direct infringement in situations heretofore cognizable only under counts sounding in indirect infringement. The invention is particularly useful in cases where the invention is intricately or functionally related to the business of the patentee, but the patentee does not make the complete invention.

### DETAILED DESCRIPTION

The present invention generally relates to methods of claiming inventions by drafting or making available for publication patent claims that can be directly infringed by acts of indirect infringement, thereby giving patentees such as component suppliers additional enforcement options. One method may include the step drafting a patent claim in a tangible medium of expression, the patent claim comprising steps that are directly infringed if an accused infringer instructs, directs, advises, teaches, suggests, conveys, communicates or illustrates any material part, element, or idea recited in a claim or combination claim of a patentee to a third party, for any commercial purpose, without legal permission from the patentee. Material may be defined as a claim part, element or idea that has been judged novel and non-obvious by a Patent Office. An entire claim may contain a single novel and non-obvious material element or the entire claim may contain a combination of novel and non-obvious parts. A Jepson-type claim allowed by a Patent Office may also contain material parts, elements, or ideas after the “wherein the improvement comprises” or “characterized in that” language. A material part, element, or idea may be paraphrased or generally described by an accused infringer, and does not have to be taken verbatim from an allowed claim.

The invention includes a method of drafting or making available for publication, a claim, such as in a tangible medium of expression, that is directly infringed if an accused infringer instructs, directs, advises, teaches, suggests, conveys, reproduces, communicates or illustrates all of the elements recited in a combination claim of a patentee to a third party without the legal permission of the patentee. A method of obtaining patent protection may include the step of drafting a patent claim that is directly infringed if an accused infringer communicates any material part, element, or idea recited or generally described in an allowed patent claim to a third party; sells, offers for sale, makes, or uses a product, process, or product by process to or for the third party that is used with the material element recited in the allowed patent claim; and the product, process, or product-by-process has at least one improved characteristic (compared to use of the product/process/PBP without the material part, element, or idea) when used with the material element recited in the allowed patent claim. The step of communication may be satisfied directly or indirectly by an electronic device, such as a photocopier, a projector, a computer, a computer monitor or screen, or other transmission device. In the electrical connector, optics, electrical cable, and printed circuit board arts, an improved characteristic may be impedance, crosstalk, reduced power consumption, reduced manufacturing cost, or improved differential or single-ended signal integrity. Other improved characteristics apply to different arts.

Another embodiment includes the steps of drafting a claim that is directly infringed if (i) a third party instructs, directs, advises, teaches, suggests, conveys, reproduces, communicates or illustrates to a customer or potential customer a material part, element, or idea recited or generally described in a patented combination claim of another and (ii) the third party sells or commercially offers for sale any product, process, or product-by-process to the customer or potential customer that contains the material part, element, or idea.

A patent claim may include any step that requires an affirmative act of communicating a material part, element, or idea, specifically or in paraphrased or general terms, of a patented claim by a party to a third party, wherein the party and the third party are not the owners of the patented material part, element, or idea. Other steps include any step that requires an affirmative act of associating the material part, element, or idea of a patented claim with a product, process, or product-by-process supplied directly or indirectly by the party and any step that requires an affirmative act of selling or making a commercial offer for sale of the product, process, or product-by-process to the third party for use with the material part, element, or idea. The product, process, or product-by-process may have an improved quality in combination with the material part, element, or idea of a patented claim. The product, process, or product-by-process supplied directly or indirectly by the party may directly compete with a similar type of product commercially available by the owner of the patented claim. The affirmative act of communicating a material part, element, or idea of a patented claim by a party to a third party may include the step of preparing or displaying a presentation via an electronic device. The affirmative act of associating the material part, element, or idea of a patented claim with a product, process, or product-by-process may include the step of preparing a presentation via an electronic device.

Another embodiment of a method of obtaining patent protection may include the step of drafting a patent claim that is fixed a patent claim in a tangible medium of expression. The patent claim may include any steps directed to the general concepts of communicating a patented material part, element, or idea of another to a third party and any steps directed to (making/using) or selling or making a commercial offer for sale of any product, process, or product-by-process element to the third party, wherein the product, process, or product-by-process is physically different than the material part, element, or idea but is functionally related with the patented material part, element, or idea. The product, process, or product-by-process has a physical or electrical property may be improved by the patented material part, element, or idea. An invention may include any step that informs the third party that an advantage can be obtained through the combined use of the patented material part, element, or idea of another and the product, process, or product-by-process. The step of communicating a patented material part, element, or idea of another to a third party may further include communicating the material part of a patented claim of another via an electronic device.

A commercial sale is typically satisfied by shipping a product or is perfected when the customer or potential customer receives a contractual quote or bid from the competitor of the patentee for a product, process, or product-by-process that incorporates the material element. One legal standard is the two-prong commercial offer for sale test set forth in Pfaff v. Wells Elecs., Inc., 525 U.S. 55 (1998), 124 F.3d 1429 (1998), the opinion of the Court hereby incorporated by reference in its entirety.

According to another embodiment, a method includes the steps of drafting a claim and fixing the claim in tangible medium of expression, such as an ADOBE .pdf file, the claim comprising the steps of instructing, directing, advising, teaching, suggesting, conveying, reproducing, communicating or illustrating one or more novel and non-obvious elements of a patented third party product, process, or product-by-process combination claim, without permission, and instructing, directing, advising, teaching, suggesting, conveying, reproducing, communicating or illustrating a commercial benefit of the one or more novel and non-obvious elements. The term “fixed” may be defined according to 17 U.S.C. §101 (2010), which is incorporated by reference in its entirety. Other examples include written text or computer hard drive, flash drive, CD, DVD, and RAM storage. This type of claim allows patent counsel to protect his or her client from competitors who make affirmative acts to advocate the use client key technology but in combination with competitive products.

According to another embodiment, a method includes a step of reducing a claim to a tangible electronic, digital, analog, visually perceptible, auditory, or written medium of expression, the claim comprising a method step that includes a gerund or any word ending in “-ing”, wherein the gerund or word ending in “-ing” is, has a meaning similar to, or is a synonym for instructing, directing, advising, teaching, suggesting, conveying, reproducing, communicating, conveying, illustrating, showing, presenting, giving, transferring, transmitting, drawing, projecting, displaying, mailing, emailing, uploading, downloading, or sketching. The claim or method step may also include a step of instructing, directing, advising, teaching, suggesting, conveying, reproducing, communicating, conveying, illustrating, showing, presenting, giving, transferring, transmitting, drawing, projecting, displaying, mailing, emailing, uploading, downloading, or sketching a patentable improvement of another to a third party, without permission, wherein the patentable improvement also directly or indirectly improves a related but distinct product, process, or product-by-process that is an element of the claimed combination.

Another method according to the claimed invention includes the step of fixing words or pictures in one or more tangible mediums of expression, wherein the words or pictures depict a novel and non-obvious element recited in a combination claim of a patentee. An additional step includes instructing, directing, advising, teaching, suggesting, conveying, reproducing, communicating, conveying, illustrating, showing, presenting, giving, transferring, transmitting, drawing, projecting, displaying, mailing, emailing, uploading, downloading, or sketching the words or pictures to a third party without permission from the patentee. A third step includes selling or offering for sale any product, process, or product-by-process described in the words or pictures.

Another method according to the claimed invention includes the step of fixing words or pictures of a patentee in one or more tangible mediums of expression, wherein the words or pictures depict all of the elements recited in a combination claim of the patentee. An additional step includes instructing, directing, advising, teaching, suggesting, conveying, reproducing, communicating, conveying, illustrating, showing, presenting, giving, transferring, transmitting, drawing, projecting, displaying, mailing, emailing, uploading, downloading, or sketching the words or pictures to a third party without permission from the patentee. A third step includes providing a quote, auction bid, customer drawing, application specification, inspection drawing, e-model, or animated drawing to the third party.

For purpose of example only, here are some sample claims that relate to the claim drafting methods described herein. Any method steps previously discussed above or described below can be added, deleted, or mixed and matched with any other method steps recited herein to make a variety of claim combinations. Moreover, articles such as electrical connectors, printed circuit board, and vias are exemplary and can be substituted with any other components. For example, a chair has a wooden frame, a covering fabric, and cushioning. An improvement to the cushioning may give the covering fabric a longer service life. The present invention can help any component manufacturer maximize its commercial competitiveness:

### EXAMPLE 1

1. A method comprising the steps of:
showing a third party drawings, models, pictures, or text that depict, either alone or in combination, a printed circuit board containing the elements recited in claim N of Patent Application 00/000,000 [where N is a stand-alone allowed independent claim or an allowed dependent claim of any United States or non-US patent application or issued patent. An alternative wording for “claim N of Patent Application No. 00/000,000” is “claim N of United States or Country X Patent No. 0,000,000”, where N is a stand-alone allowed independent claim or an allowed dependent claim and X is the name of a country with a patent system in place];
conveying to the third party one commercial advantage of the printed circuit board recited in claim N; and
showing the third party an electrical connector configured to attached to the printed circuit board,
wherein the electrical connector is visually different [such as by applying the United States Design Patent “confusing similar” standard] than the electrical connector shown in FIGS. 1-10 of United States Patent Application 00/000,000.

In Example 1, manufacturers typically do not depict competitive product offerings in their own product presentations. If FIGS. 1-10 of the patent application contain a specific product manufactured or sold by the patentee, it is more likely that a potential infringer will substitute its own product in place of the product shown in the patent application. Patentees can make a claim like Example 1 even stronger by filing a design case for the product shown in FIGS. 1-10. A commercial advantage or benefit includes, but is not limited to, a reduction in cost, a reduction or an increase in size, ease of manufacturing, speed of manufacturing, increased electrical signal integrity performance to include a reduction in crosstalk, a reduction in insertion loss, a reduction in precious metal use, a reduction in resin use, better impedance matching, or mechanical advantage or performance.

### EXAMPLE 2

2. A method comprising the steps of:
showing a third party one or more tangible drawings, models, pictures, or text that depict, either alone or in combination, a printed circuit board and electrical connector that is visually different than the electrical connector shown in FIGS. 1-10 of United States or country X Patent Application 00/000,000, wherein the printed circuit board shown to the third party depicts, shows, or describes a T-shaped via, the electrical connector shown to the third party is configured to mount to the T-shaped via of the printed circuit board, and the electrical connector shown to the third party has one improved electrical characteristic as compared to an identical electrical connector mounted to a printed circuit board that does not have a T-shaped via.

Example 2 specifically recites a patentable improvement to the PCB, namely a T-shaped via. It is recommended that the claim in Example 2 be accompanied by a claim in the same patent application or a related patent application that is directed strictly to a PCB with a T-shaped via.

### EXAMPLE 3

3. A method comprising the steps of:
fixing one or more drawings, models, pictures, or text in one or more tangible mediums of expression, wherein the drawings, models, pictures, or text depict or describe an electrical connector and a printed circuit board as claimed in claim N [where N is a stand-alone allowed independent claim or an allowed dependent claim in the same patent application or in a different patent application]; and
teaching, visually or by sound, one commercial benefit the combined electrical connector and printed circuit board to the third party,
wherein the electrical connector does not meet each and every element of claim 1 of U.S. Pat. No. 0,000,000.

Example 3 is another way of re-stating the claim in Example 2. Example 3 assumes that the electrical connector shown in FIGS. 1-10 would read on claim 1 of another apparatus patent owned by the patentee.

### EXAMPLE 4

4. A method comprising the steps of:
fixing drawings, models, pictures, or text in one or more tangible mediums of expression, wherein the drawings, models, pictures, or text depict or describe a printed circuit board as claimed in claim N [where N is a stand-alone allowed independent claim or an allowed dependent claim] of this patent application and an electrical connector other than the connector shown in FIGS. 1-10 of this patent application that is configured to attach to the printed circuit board;
communicating the drawings, models, pictures, or text to a third party; and
offering for sale or selling the electrical connector directly or indirectly to the third party, wherein one the electrical connector has one electrical performance characteristics that are improved by the printed circuit board as claimed in claim M (where M is an allowed independent or dependent apparatus claim in the same patent application as claim N).

Example 4 requires an act of selling or offering for sale. The alleged infringer would also be the entity who prepares and presents a presentation to a customer or potential customer.

### EXAMPLE 5

5. A method comprising the steps of:
creating or copying drawings, models, pictures, or text that depict or describe, either alone or in combination, a printed circuit board containing all of the elements recited in claim N [where N is a stand-alone allowed independent claim or an allowed dependent claim] of this patent application;
communicating the drawings, models, pictures, or text to a third party;
communicating at least one price, size, or performance advantage of the printed circuit board recited in claim N of this patent application to the third party; and
supplying or offering for sale an electrical connector to the third party, the electrical connector configured to attach to the printed circuit board recited in claim N.

Proof of infringement can be a product presentation given to a customer in the United States, along with a program purchase order or reverse auction program bid by the accused infringer.

### EXAMPLE 6

6. A method comprising the steps of:
creating or copying drawings, models, pictures, or text in one or more tangible mediums of expression, wherein the drawings, models, pictures, or text depict or describe the patented product combination (or process or product-by-process) recited in claim N [where N is a stand-alone allowed independent claim or an allowed dependent claim];
communicating, without permission from the owner of claim N, the drawings, models, or pictures to a third party; and
supplying at least one element of the patented product combination to the third party.

### EXAMPLE 7

7. A method comprising the steps of:
creating or copying drawings, models, pictures, or text that depict or describe, either alone or in combination, a printed circuit board comprising T-shaped vias; and
communicating the drawings, models, pictures, or text to a third party;
providing a price and quantity quote to the third party for an electrical connector configured to attach to the printed circuit board.

The foregoing description is provided for the purpose of explanation and is not to be construed as limiting the invention. While the invention has been described with reference to preferred embodiments or preferred methods, it is understood that the words which have been used herein are words of description and illustration, rather than words of limitation. Furthermore, although the invention has been described herein with reference to particular structure, methods, and embodiments, the invention is not intended to be limited to the particulars disclosed herein, as the invention extends to all structures, methods and uses that are within the scope of the appended claims. Those skilled in the relevant art, having the benefit of the teachings of this specification, may affect numerous modifications to the invention as described herein, and changes may be made without departing from the scope and spirit of the invention as defined by the appended claims.

I claim:

1. A method of obtaining patent protection comprising the step of: drafting a patent claim that is directly infringed if an accused infringer communicates any material element recited in an allowed patent claim to a third party; sells, offers for sale, makes, or uses a product, process, or product by process to or for the third party, wherein the product, process, or product by process is used with the material element recited in the allowed patent claim; and the product, process, or product-by-process has at least one improved characteristic when the product, process, or product-by-process is used with the material element recited in the allowed patent claim.

2. The method of obtaining patent protection as claimed in claim 1, wherein the improved characteristic is selected from the group comprising: impedance, crosstalk, reduced power consumption, reduced precious metal use, reduced resin use, improved differential signal integrity, and improved single-ended signal integrity.

3. The method of obtaining patent protection as claimed in claim 1, wherein material element is communicated to the third party directly or indirectly by an electronic device.

4. A method of obtaining patent protection comprising the step of drafting a patent claim in a tangible medium of expression, the patent claim comprising any steps directed to:
a) communicating a patented material part, element, or idea of another to a third party; and
b) selling or making a commercial offer for sale of any product, process, or product-by-process element to the third party, wherein the product, process, or product-by-process is structurally different than the material part, element, or idea but is functionally related with the patented material part, element, or idea, and the product, process, or product-by-process has a physical or electrical property that is improved when used with the patented material part, element, or idea of another.

5. The method of obtaining patent protection as recited in claim 4 wherein the step of communicating a patented material part, element, or idea of another to a third party further includes communicating the patented material part, element, or idea of another via an electronic device.

6. The method of obtaining patent protection as recited in claim 4 wherein the step of communicating a patented material part, element, or idea of another to a third party further includes the step of preparing a presentation via an electronic device prior to communicating the patented material part, element, or idea of another.

7. A patent claim comprising:
any step that generally requires an affirmative act of communicating a material part, element, or idea of a patented claim by a party to a third party, wherein the party and the third party are not the owners of the patent claim;
any step that requires an affirmative act of associating the material part, element, or idea of the patent claim with a product, process, or product-by-process supplied directly or indirectly by the party; and
any step that requires an affirmative act of selling or making a commercial offer for sale of the product, process, or product-by-process to the third party for use with the material part, element, or idea of the patent claim.

8. The patent claim as recited in claim 7, wherein the product, process, or product-by-process has an improved quality in combination with the material part, element, or idea.

9. The patent claim as recited in claim 7, wherein the product, process, or product-by-process supplied directly or indirectly by the party directly competes with a similar type of product commercially available by the owner of the patent claim.

10. The patent claim as recited in claim 7, wherein the affirmative act of communicating a material part, element, or idea of a patented claim by a party to a third party comprises the step of preparing a presentation via an electronic device.

11. The patent claim as recited in claim 10, wherein the affirmative act of associating the material part, element, or idea of the patent claim with a product, process, or product-by-process comprises the step of preparing a presentation via an electronic device.

12. The patent claim as recited in claim 7, wherein the affirmative act of associating the material part, element, or idea of the patent claim with a product, process, or product-by-process comprises the step of preparing a presentation via an electronic device.
